(19) United States
(12) Patent Application Publication
(10) Pub. No.: US 2012/0042427 A1
(43) Pub. Date: Feb. 23, 2012

(54) Coatings for Elastomeric Products

(75) Inventor: Pierre J. Messier, Quebec (CA)

(73) Assignee: TrioMed Innovations Corp., South Burlington, VT (US)

(21) Appl. No.: 13/053,676

(22) Filed: Mar. 22, 2011

Related U.S. Application Data
(60) Provisional application No. 61/316,087, filed on Mar. 22, 2010.

(51) Int. Cl. A41D 13/08; B05D 1/36; B05D 1/18; B05D 7/02; B05D 3/00

(52) U.S. Cl. 2/16; 427/393.5

(57) ABSTRACT

A medical glove and other elastomeric healthcare products are provided. The glove includes a base comprised of an elastomeric polymer; a barrier coating over the base; a secondary coating over the barrier coating; and a plurality of iodinated resin particulates anchored to the secondary coating. A method of coating an elastomeric material is also provided, which includes: (a) providing a base elastomer comprised of an elastomeric polymer; (b) dipping the elastomer in a first organic solution containing a polymer to form a barrier coating; (c) dipping the elastomer in a second organic solution containing a polymer to form a secondary coating over the barrier coating; (d) dipping the elastomer in an a suspension containing iodinated resin particulates in an organic solvent to anchor the particulates to the secondary coating; and (e) drying the elastomer.

### CROSS-REFERENCE TO RELATED APPLICATIONS

This applications claims the benefit of U.S. provisional application 61/316,087, filed on Mar. 22, 2010, the entirety of which is incorporated herein.

### FIELD OF THE INVENTION

The present invention relates to coated elastomeric products and methods for coating elastomeric products, for example, gloves and catheters.

### BACKGROUND OF THE INVENTION

Elastomeric products are used in many healthcare related applications. For example, disposable elastomeric gloves protect a wearer from harmful microorganisms or contaminated biological fluids. The disposable gloves are usually generated from elastomeric materials such as natural rubber latex, nitrile latex, neoprene latex and polyisoprene dispersions. The majority of powder-free gloves being used today have a polymer coating or are chlorinated on the inner surface of the glove. The polymer coatings must be durable and must adhere to the underlying elastomeric material. Additionally, the outer surface of the elastomeric glove usually contains a lubricant such as a polymer or a crosslinked polymer.

One problem with commercially available disposable gloves is that they often, during use, come in contact with exposed surfaces, potentially contaminating the surface. This is particularly an issue during surgeries, medical examinations and dental procedures where the gloves used by a doctor or dentist are exposed to dangerous microbes. Besides contaminating surfaces, there is the potential for cross-contamination of other patients and contamination of the doctor or dentist wearing the gloves.

Catheters are indispensable tools in the medical field that help with drainage of numerous fluids (urine, blood, abscess, etc.). Similar to surgical gloves, catheters are generally made from elastomeric materials. Catheters are lubricated on their outer surface to facilitate insertion through a luminal orifice of a human body. It is extremely important that catheters are resistant to microorganisms and other toxins to avoid deleterious infections. One means of preventing such infection is to add an antimicrobial coating to the surface of the catheter. Although there are catheters with coatings that combat infections currently on the market, they often do not provide a high level of efficacy or a wide range of activity.

Accordingly, there exists a need to develop elastomeric products, such as gloves and catheters, which offer full protection against a large array of toxins and other contaminants. Ideally, the elastomeric products should be highly efficacious against the toxins (e.g., microorganisms) while at the same time have a high durability and stretchability. Moreover, the elastomeric products must demonstrate excellent toxicological performance.

### SUMMARY OF THE INVENTION

In accordance with this invention the aforementioned goals have been met with new antimicrobial coatings for elastomeric products. The antimicrobial products contain a sufficient quantity of an antimicrobial agent, particularly a demand disinfectant iodinated resin, to exert a toxic effect on a large diversity of microorganisms and other contaminants.

One aspect of the present invention includes an antimicrobial catheter comprised of an elastomeric polymer which is coated with a barrier coating and a secondary (binder) coating, wherein the secondary coating has iodinated resin particulates anchored to its surface.

Another aspect of the present invention includes an antimicrobial glove comprised of an elastomeric polymer which is coated with a barrier coating and a secondary (binder) coating, wherein the secondary coating has iodinated resin particulates anchored to its surface.

Another aspect of the present invention includes a method for coating an elastomeric catheter comprising the steps of applying a barrier coating directly over the catheter, applying a secondary coating over the barrier coating, and applying a suspension of iodinated resin in an organic solution over the barrier coating.

Another aspect of the present invention includes a method for coating an elastomeric glove comprising the steps of applying a barrier coating directly over the catheter, applying a secondary coating over the barrier coating, and applying a suspension of iodinated resin in an organic solution over the barrier coating.

### BRIEF DESCRIPTION OF THE DRAWINGS

FIG. 1 is a schematic side view of an elastomeric article formed in accordance with one embodiment of the present invention.

### DETAILED DESCRIPTION

The following sections describe exemplary embodiments of the present invention. It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto.

Throughout the description, where items are described as having, including, or comprising one or more specific components, or where processes and methods are described as having, including, or comprising one or more specific steps, it is contemplated that, additionally, there are items of the present invention that consist essentially of, or consist of, the one or more recited components, and that there are processes and methods according to the present invention that consist essentially of, or consist of, the one or more recited processing steps.

It should be understood that the order of steps or order for performing certain actions is immaterial, as long as the invention remains operable. Moreover, two or more steps or actions may be conducted simultaneously. Scale-up and/or scale-down of systems, processes, units, and/or methods disclosed herein may be performed by those of skill in the relevant art. Processes described herein are configured for batch operation, continuous operation, or semi-continuous operation.

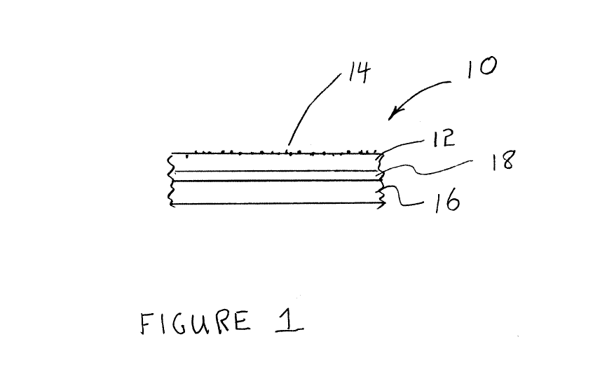

Referring to FIG. 1, the present invention is directed to an elastomeric article 10 having an outer coating 12, wherein a sufficient amount of iodinated resin 14 is anchored to the outer coating 12 to impart antimicrobial properties to the treated article. The present invention is further directed to the production of such antimicrobial elastomeric articles.

Iodine/resin demand disinfectants are known in the art. For example, U.S. Pat. No. 5,639,452 (“the '452 patent”), to Messier, the entire contents which are hereby incorporated by reference, describes a process for preparing an iodine demand disinfectant resin from an anion exchange resin. The demand disinfectant iodinated resins described in the '452 patent may be ground into a powder. An embodiment of the present invention is Triosyn® brand iodinated resin powders made by Triosyn Research Inc., a division of Triosyn Corporation of Vermont, USA. The particle sizes of the powders range from about 1 micron to about 50 microns. Preferably, the particle sizes should be 10 microns and under.

Two such Triosyn® iodinated resin powders used in accordance with the present invention are referred to as Triosyn® T-50 iodinated resin powder and Triosyn® T-45 iodinated resin powder. The numbers refer to the approximate weight percentage of iodine relative to the resin. Powders with other weight percentages of iodine may also be used in accordance with the present invention. Different percentages of iodine in the iodinated resin powders will confer different properties to the powder, in particular different levels of biocidal activity. The particular resin used is based on the desired application. It is important to note that iodinated resin from other sources can also be used.

As described below, the iodinated resin particulates are contained within polymeric coatings on the elastomeric product 16 (e.g., catheter of glove). The polymeric coating on the elastomeric article should be able to secure the Triosyn® iodinated resin powder sufficiently. The Triosyn® iodinated resin powder should not rub off the elastomer. Furthermore, the coating should be able to withstand contact with various surfaces without losing the Triosyn® resin powder. At the same time, there should be enough iodinated resin in the polymer to exert a toxic effect on a large variety of different microbes. Moreover, the coating should not hinder the user from handling objects.

In one embodiment of the present invention, a method for manufacturing antimicrobial catheters is provided. The catheter is comprised of an elastomeric material 16 such as a latex, nitrile or silicone. The catheter is coated with at least two separate layers, an inner barrier layer 18 and an outer layer 12. The coating layers are comprised of polymeric materials. The primary function of the inner layer 18 is to serve as a barrier between the base of the catheter 16 and the outer (secondary) layer 12 containing the iodinated resin 14. Hence, polymers were chosen to adhere strongly to the base catheter while at the same time preventing iodine from migrating to the base. A variety of polymers may be used for the barrier layer including but not limited to polyurethanes, polyacrylics, modified polyacrylics, hydrogel polymers, polyacrylic/polyurethane blends, and acrylonitrile-based polymers. Preferred polymers include aliphatic polyester urethanes such as TECOPHILIC TG-2000 and TECOPHILIC SP-93A-100 and aromatic polyuretahanes such as TECHOTHANE TT-1074A. The aromatic polyurethanes are most preferred.

The barrier layer 18 is preferably applied by dipping the catheter (one or two times) in an organic solution containing the polymer. A preferred organic solvent is THF. The weight percentage of the polymer in the organic solution may vary between 1 to 20% wt/wt, preferably between 2.0% to 5.0% t/wt and most preferably about 2.5% wt/wt. It was found, for instance, that 2.5% wt/wt as TECHOTHANE TT-1074A in THF, after application to a natural rubber latex (NRL) catheter surface and subsequent drying, provided a sufficient quantity to bind a secondary polymer (discussed below), prevent visually (microscopically) stress cracks in the substrate surface and provide rapid drying and more even flow (minimize build-up at distal end of sample) upon extraction.

After application of the barrier layer, a secondary (binder) layer 12 is applied on top of the barrier layer 18. As with the barrier layer 18, a variety of polymers may be used for the secondary layer including but not limited to polyurethanes, polyacrylics, modified polyacrylics, hydrogel polymers, polyacrylic/polyurethane blends, and acrylonitrile-based polymers. Preferred polymers are aliphatic polyester urethanes such as TECOPHILIC SP-93A-100. In one embodiment of the present invention, the catheter with the barrier layer 18, prepared as described above, is dipped into an organic solution containing TECOPHILIC SP-93A-100. The organic solution is preferably THF. The concentration of TECOPHILIC SP-93A-100 in THF may vary between 1% to 5% wt/wt, and more preferably 1% to 3% wt/wt. In a preferred embodiment, the concentration of the TECOPHILIC SP-93A-100 in THF is about 1.5% wt/wt. It has been found that addition of an organic acid provides for improved overall properties of the coated catheters. As an example, citric acid may be added to the solution of THF containing TECOPHILIC SP-93A-100 to bring the pH to between 3 and 4. After drying, the catheter contains both a barrier layer 18 and a secondary layer 12 coated directly on top of the barrier layer.

In accordance with the present invention, after application of the barrier layer and the secondary layer on the elastomeric catheter, the coated catheter is dipped into an organic suspension of iodinated resin particulates and then dried. Dipping may be applied multiple times, preferably two times. Preferably, the particulates are Triosyn® T-50 iodinated resin powder or Triosyn® T-45 iodinated resin powder. After drying and evaporating the organic solvent, the iodinated resin particulates 14 are anchored to the secondary layer 12 to a sufficient degree as to prevent the particulates from rubbing or flaking off when handled. It is noted that the iodinated resin particulates are not sufficiently encapsulated in the secondary polymeric coating.

In one embodiment of the present invention, the iodinated resin particulates 14 are dipped into a solution of THF:acetone at a particular ratio. The co-solvent system is selected to ensure appropriate anchoring of the iodinated resin particulates to the secondary layer 12. The ratio between the THF and the acetone may vary between about 2:1 to about 1:4. The ratio will be dependent on the nature of the secondary coating applied to the catheter. For instance, if TECOPHILIC SP-93A-100 is applied as a secondary coating, the iodinated resin suspension is preferably added to an organic co-solvent system in a ratio between 2:4 to 2:5 THF/acetone. The concentration of the iodinated resin particulates is chosen to optimize biological performance of the catheter while at the same time generating a smooth surface without the potential for resin to rub off. For Triosyn® T-50 iodinated resin powder, the concentration of the resin may vary between about 5% to about 20%, and preferably from about 8% to about 12%. For example, it has been found that dipping catheters coated with a barrier layer and secondary layer suspensions containing Triosyn® T-50 iodinated resin powder at a concentration of about 12% in THF/acetone (2:5 ratio or 2:4.5 ratio) generate catheters with outstanding stability and biological performance.

In another embodiment of the present invention, elastomeric gloves are coated using a procedure similar to that described above with elastomeric catheters. The gloves are preferably made of latex or nitrile rubber. The elastomeric glove is coated with a barrier layer and dried. The resultant glove, coated with a barrier layer comprising a polymer, is subsequently coated with a secondary layer comprising a polymer. After drying, the glove is then dipped into an organic solution containing iodinated resin particulates. The resultant glove exhibits outstanding stability and biological performance.

Another aspect of the present invention involves coating prophylactics with a Triosyn® iodinated resin powder. For example, the coatings of the present invention may be used to coat condoms. The procedure for coating the condoms is generally the same as the procedure used to coat catheters and gloves.

### EXAMPLES

A natural rubber latex (NRL) catheter was used as a test substrate. Samples for microbiological efficacy were then prepared using the TECHOTHANE TT-1074A formulation as the barrier/tie coat, the TECOPHILIC SP-93A as the secondary coating and a 12% Triosyn® T-50 powder, 10 μm suspension in a solvent blend ratio of 2:5 THF/acetone with citric acid (pH=3.25) to coat the catheters. Other samples were prepared in identical fashion but with the secondary layer solution (TECOPHILIC SP-93A) being dissolved in THF/acetone at a ratio of 2:4.5. All coatings were applied under laboratory hand dipped techniques using 2× dips for each of the formulations. The TECHOTHANE TT-1074 was air dried in a heppa hood overnight after coating and prior to application of the TECOPHILIC SP-93A secondary coating. The TECOPHILIC SP-93A coating was dried in the heppa hood overnight after coating and prior to application of the Triosyn® T-50 powder suspension. After application of the TRIOSYN® T-50 suspension, the dips were allowed to dry overnight and then packaged for testing.

Samples were first evaluated for iodine neutralization (visual absence of color). The sample was placed under the microscope at 40× magnification and 1 drop of 0.1N Na₂S₂O₃ was placed on the visual surface and the timer started. Neutralization of iodine was visually initiated in between 5 minutes and 7 minutes and completed in between 30 minutes and 40 minutes.

Samples were then submitted for microbiological testing to determine microbiological efficacy. Test results described below were conducted with samples prepared in accordance with the procedure described above utilizing the secondary coating comprising the TECOPHILIC SP-93A dip solution in a 2:4.5 ratio of THF/acetone at a pH of 3.26. The test organism used to evaluate performance was Pseudomonas aeruginosa ATCC 9027. The initial concentration of the test organism was 1.3×10⁷ CFU/1.0 mL. Tests were conducted on individual pieces of approximately 50 mm each. The following sample medium was used:

Culture medium: Soybean Casein Digest Broth

Inoculum Carrier: Phosphate Buffered Water

Growth Medium: Tryptic Soy Agar

Neutralizer: Phosphate Buffered Salime containing 0.5% Tween 80 and 0.1% sodium thiosulfate

Test samples were placed onto a wrist action shaker in a 35° C.-39° C. incubator on the lowest rpm setting for 72 hours. Results observed for coated samples (NRL catheters) containing iodinated resin are displayed in Table 1.

TABLE 1

| Sample | Replicate 1 | Replicate 2 | Replicate 3 |
|---|---|---|---|
| Initial Contact Time | 1.2 × 10⁷ | 1.2 × 10⁷ | 1.2 × 10⁷ |
| (Concentration) | | | |
| 72 Hour Contact Time | <1.0 × 10¹ | <1.0 × 10¹ | <1.0 × 10¹ |
| (Concentration) | | | |
| Log reduction | >6.1 | >6.1 | >6.1 |

The Table reveals that the catheters coated in accordance with the present invention display a very high level of efficacy, showing reductions in bacterial concentration of more than six orders of magnitude. Control samples were also prepared without iodinated resin. Microbiological tests were run under identical conditions as those described above. In contrast to results shown in Table 1, in the control tests, no reduction in the concentration of the microorganism was observed.

Although illustrative embodiments of the present invention have been described herein, it is to be understood that the invention is not limited to those precise embodiments, and that various other changes and modifications may be applied therein by one skilled in the art without departing from the scope or spirit of the invention.

1-6. (canceled)

7. A medical glove comprising a base comprised of an elastomeric polymer; a barrier coating over said base; a secondary coating over said barrier coating; and a plurality of iodinated resin particulates anchored to said secondary coating.

8. A method of coating an elastomeric material, comprising:
(a) providing a base elastomer comprised of an elastomeric polymer;
(b) dipping said elastomer in a first organic solution containing a polymer to form a barrier coating;
(c) dipping said elastomer in a second organic solution containing a polymer to form a secondary coating over said barrier coating;
(d) dipping said elastomer in an a suspension containing iodinated resin particulates in an organic solvent to anchor said particulates to said secondary coating; and
(e) drying said elastomer.

9. The method of claim 8, wherein the first organic solution contains an organic acid.

10. The method of claim 9, wherein the organic acid is citric acid.

11. The method of claim 8, wherein the first organic solution is comprised of THF.

12. The method of claim 8, wherein the second organic solution is comprised of THF.

13. The method of claim 8, wherein the iodinated resin particulates are suspended in a mixture of acetone and THF.

14. The method of claim 13, wherein the ratio of THF/acetone is between 2:4 and 2:5.
